(19) United States
(12) Patent Application Publication
(10) Pub. No.: US 2026/0070819 A1
(43) Pub. Date: Mar. 12, 2026

(54) WATER TREATMENT DEVICE WITH SIMPLE CONFIGURATION THAT USES ELECTROSTATIC FIELD

(71) Applicant: U&G Technology Co., Ltd., Incheon (KR)

(72) Inventor: Sanguk KIM, Incheon (KR)

(73) Assignee: U&G Technology Co., Ltd., Incheon (KR)

(21) Appl. No.: 19/322,326

(22) Filed: Sep. 8, 2025

(30) Foreign Application Priority Data
Sep. 9, 2024 (KR) 10-2024-0122646

(51) Int. Cl. C02F 1/48

(52) U.S. Cl. CPC C02F 1/48; C02F 2201/004; C02F 2307/14

(57) ABSTRACT

Provided is a water treatment device with a simple configuration that uses an electrostatic field, which can be assembled and disassembled to and from a pipe through which water flows to treat the passing water into water with a reduced hardness that can be used as sterilizing water and can also suppress rust generation, and the water treatment device can be manufactured with a simple structure, thereby reducing manufacturing costs.

### CROSS-REFERENCE TO RELATED APPLICATION

This application claims priority to Korean Patent Application No. 10-2024-0122646, filed in the Korean Intellectual Property Office on Sep. 9, 2024, the entire contents of which are hereby incorporated by reference.

### BACKGROUND

### 1. Field of the Invention

The present disclosure relates to a water treatment device with a simple configuration that uses an electrostatic field, and more specifically, to a water treatment device with a simple configuration that uses an electrostatic field, which can be assembled and disassembled to and from a pipe through which water flows to treat the passing water into water with a reduced hardness that can be used as sterilizing water and can also suppress rust generation, and the water treatment device can be manufactured with a simple structure, thereby reducing manufacturing costs.

### 2. Description of Related Art

Water treatment devices are installed in pipes that supply water for various uses, cool water, hot water, and the like to various buildings that require water such as factories, apartments, swimming pools, and bathhouses, and are used to prevent corrosion and red water of the pipes and also prevent the generation and accumulation of bacteria or scales in the pipes. To prevent and remove such scale, a method of applying an electric field to the pipe, that is, a method using an electrostatic field, is used. Like a capacitive capacitor, a general water treatment device using an electrostatic field serves as a dielectric with positively (+) and negatively (−) charged surfaces.

For example, when positive (+) and negative (−) electrodes of a direct current or a pulsed direct current are applied to a cylindrical or flat pipe, an electrostatic field is generated between the positive (+) and negative (−) electrodes. When water is present between the positive electrode (+) and the negative electrode (−), an electric field is charged across the water. For the treatment of a large area and large capacity, a flat water treatment device having a positive electrode (+) and a negative electrode (−) configured in a flat plate shape may be provided. That is, the principle of the electrostatic water treatment device described above is to apply a very high DC voltage or pulse voltage (maximum of 1,000 V or more) to the positive electrode (+) and negative electrode (−) of the pipe or flat structure to affect particles, bacteria, and the like in the water. In this case, the magnitude of the current is very small (0.01 A or less) and it does not affect the performance of the device.

The cell membrane of the bacteria present in water consists of a lipid bilayer, which includes hydrophilic heads and hydrophobic tails. Substances entering the cell move through proteins embedded in the cell membrane, and the composition of the cell membrane is maintained by a proper balanced surface tension among phospholipids. When bacteria are present in the electrostatic water treatment device with very large electrostatic field, the surface tension characteristics of bacteria transported within the water flow are altered by the strong electrostatic field, disrupting the balance of the cell membrane. As a result, the position and structure of the hydrophilic heads and the hydrophobic tails of phospholipids change, resulting in rearrangements and disruptions. In this process, a pore is formed in the cell membrane, allowing external substances such as water and ions to enter the cell, causing the bacteria swell and die.

In addition, the electrostatic water treatment device with very large electrostatic field supply electrons to water flowing between the positive (+) and negative (−) electrodes, electrically neutralizing cations (Ca²⁺, Mg²⁺, and Fe²⁺), which are scale components, to create repulsive force that prevents scale formation. Accordingly, not only is the generation of the scale prevented, but the existing crystal compounds of the scale deposited on the discharge pipes can also be removed. In addition, abundant electrons are supplied to the water can suppress corrosion caused by the loss of electrons from the metal.

The electrostatic water treatment device operates on the principle of a capacitor, utilizing the high dielectric constant (ε≈80) of water. For example, in the electrostatic water treatment device, dielectric electrodes with positive (+) and negative (−) surfaces are configured similarly to capacitors as follows. The electrodes may be classified as those with high potentials and those with low potentials. In this case, the potential of 0 V is connected to the ground, and the ground serves as the negative (−) electrode, while the high potential (approximately +1,000 V or −1,000 V) serves as the positive (+) electrode. A large amount of current flows through water present between the surfaces of the positive (+) and negative (−) electrodes.

In order to minimize current flow and construct electrodes based on the principle of capacitive capacitors, the positive electrode (+) at high potential is connected to a conductor such as copper, aluminum, titanium, iron, and the like, and the conductor is tightly sealed with an insulating film made of rubber, ceramic, Teflon, polyethylene, polypropylene, polyurethane, PVC, and the like, ensuring stable insulation and durability (of 5 years or more) under applied high voltage. The negative electrode (−) includes a conductor and is connected to both a water connection pipe body and ground.

In addition, in the electrostatic water treatment device, an electrode rod is installed inside a cylindrical pipe through which water flows. The negative (−) electrode is applied to the cylindrical pipe, and the positive (+) electrode is applied to the internal electrode rod disposed within the cylindrical pipe. The critical factor is ensuring the stable insulation of the internal electrode rod.

In a related electrostatic water treatment device, an insulating film is employed to electrically isolate the internal electrode rod. In this case, there is a difficulty in assembling, and even a pinhole in the insulating film can lead into insulation failure. Therefore, special care must be taken to ensure the protection of the insulating film on the internal electrode rod.

For the internal electrode rod, Teflon may be used as the insulating film. However, Teflon is difficult to process and is also expensive. The electrostatic water treatment device that uses Teflon exhibits very short durability under high voltage, resulting in a reduced replacement cycle for the electrode rod. Therefore, the use of Teflon can lead to increased maintenance costs.

For the insulation of the internal electrode rod, ceramic may be used as the insulating film. However, ceramic is difficult to process and is also expensive. Ceramics have the advantage of very long durability, but also have the disadvantage of being fragile and difficult to handle.

In addition, in the related electrostatic water treatment device, the water inlet direction and the water outlet direction are perpendicular to each other, which makes the electrostatic water treatment device resistant to water flow.

In addition, the related electrostatic water treatment device is difficult to install within existing pipe systems. In view of these issues, a electrostatic water treatment device has been proposed.

In detail, this related electrostatic water treatment devices includes a water inlet fixture connected to the pipe through which water is introduced, a turbo generator fixed to the water inlet fixture and configured to generate electricity, an electrostatic water treatment unit configured to use high voltage to remove bacteria or scale included in the water introduced through the tube, a fixing part connected to the electrostatic water treatment unit and fixed to the turbo generator, a high-voltage converter configured to convert the voltage generated by the turbo generator to a high voltage, a filter configured to filter the water that has passed through the electrostatic water treatment unit, a water outlet fixture connected to the water outlet pipe, and a turbo generator disposed between the water inlet fixture and the water outlet fixture, a main body configured to cover the electrostatic water treatment unit, the fixing part, the high-voltage converter, and the filter, the electrostatic field water treatment unit includes a high-voltage unit supplied with high voltage and a ground unit connected to the ground and used as a pipe through which water passes, the high-voltage unit is disposed at a center portion of the ground unit, and the high-voltage unit includes a high-voltage insulation cable through which high voltage is supplied, and an electrode case configured to cover the high-voltage insulation cable and made of a non-conductor, the pipe is formed of any one of conductive iron, aluminum, copper, and titanium, the high voltage is a DC voltage or a pulse voltage, and the high voltage has a value in the range of +1,000 V to −1,000 V, the non-conductor is formed of any one of glass, polyethylene, polypropylene, PVC, and Teflon, the current is 0.01 A or less, and water input and output directions in the ground unit are either both provided at one end of the ground unit or at both ends.

However, the related electrostatic water treatment device configured as described above has the disadvantage of reduced water treatment efficiency due to the long distance between the high-voltage unit and the ground unit.

In consideration of the above, a water treatment device using an electrostatic field has been proposed in Korean Laid-open Patent Publication No. 10-2024-0092285.

In detail, this related water treatment device using the electrostatic field includes a housing configured with a conductor and installed on a pipe through which water flows, allowing water to enter and exit, a ground unit made of a conductor, one end of which is fixed to a bottom of the housing, while the other end includes plurality of ground plates for the ground unit spaced apart at predetermined intervals and protruding upward, allowing water to come into contact, a high-voltage unit installation member formed in a plate shape so as to be seated on an upper surface of the housing and fixed with plurality of fixation screws with a sealing ring interposed therebetween, and including, formed on an upper surface, plurality of high-voltage unit accommodation holes having a slot shape at predetermined intervals, and formed on a bottom surface, plurality of high-voltage unit accommodation pieces including the high-voltage unit accommodation holes, protruding downward with accommodation grooves formed therein and spaced apart from each other and formed at predetermined intervals so that the ground plates for ground unit, of the ground unit, are inserted into spaces between the high-voltage unit accommodation pieces, in which, on the upper surface, epoxy for insulation is filled up to the accommodation grooves of the high-voltage unit accommodation pieces, a high-voltage unit including one end inserted into the high-voltage unit accommodation pieces of the high-voltage unit installation member, and the other ends protruding and connected to each other through connecting bars, a high-voltage converter installed on an upper surface of the high-voltage unit installation member while a portion thereof is buried in epoxy to convert voltage supplied from the outside into a high voltage to connect a positive electrode to the connecting bars connecting the high-voltage units to each other and connect a negative electrode to any one of the plurality of screws fixed to the housing, and a cover unit including a fixation screw hole formed on an upper surface for fixing with a screw while covering an upper portion of the high-voltage unit installation member, and a power supply jack installed on an outer peripheral surface to supply power to the high-voltage converter.

Meanwhile, although the related water treatment device using the electrostatic field with the configurations described above can ensure that sufficiently low hardness of water is obtained even when the water treatment device is configured in a small size and installed on a pipe through which water flows, it has the disadvantage of being complex in configuration due to presence of the components such as the ground unit, the installation member for the high-voltage unit, the high-voltage unit, and so on, which inevitably increases the manufacturing cost.

### SUMMARY

Accordingly, the present disclosure has been devised to solve the problems described above, and an object of the present disclosure is to provide a water treatment device with a simple configuration that uses electrostatic field, which can be assembled and disassembled to and from a pipe through which water flows to treat the passing water into water with a reduced hardness that can be used as sterilizing water and can also suppress rust generation, and the water treatment device can be manufactured with a simple structure, thereby reducing manufacturing costs.

Other objects of the present disclosure will be clear upon reading the description below.

In order to achieve the above and other objects, embodiments of the present disclosure provide a water treatment device with a simple configuration that uses an electrostatic field, including a water treatment housing 110 installed on a pipe through which water flows, allowing the water to enter and exit, and including a power line passage hole 112c formed on one side of an upper surface to receive power through a power line of a power supply unit, a water treatment gap-maintaining member 120 made of a non-conductive material, which is formed as an enclosure with an open upper surface and configured such that, when accommodated in the water treatment housing 110, an outer peripheral surface thereof can be spaced apart so as not to obstruct an inflow of water, a water treatment power converter 130 accommodated in the water treatment gap-maintaining member 120 and including (+) and (−) voltage input lines 132a and 132b and a high voltage output line 134a to receive power from outside through power lines and convert an input voltage into high voltage and output the high voltage, wherein the (+) electrode lines of the power lines are connected to each other, and the (−) electrode lines are connected together to the water treatment housing 110, a water treatment high-voltage unit 140 provided as a conductor and installed between the water treatment power converter 130 and the water treatment gap-maintaining member 120 to be connected to the high voltage output line 134a to generate static electricity between itself and an inner surface of the water treatment housing 110, and a water treatment epoxy molding layer 150 filled in an upper surface of the water treatment power converter 130 to electrically isolate the same and also to prevent hard, converted water from externally leaking through a power line passage hole of the water treatment housing 110.

In addition, the water treatment housing 110 may include a receptacle 111 formed as an enclosure and including an inlet 111a formed on one side to be connected to a first pipe to allow water to enter, in which the other side open, and a cover unit 112 formed as a plate to cover and fixed, and including an outlet 112a formed in a center of the plate to allow water with reduced hardness to be discharged to a second pipe side, and may further include a fixing screw groove 112b formed on one side of the outlet 112a of the cover unit 112, through which the (−) voltage input line 132b of the water treatment power converter 130 is connected to the (−) electrode line of the power lines supplied from the outside and then welded or fixed together by means of the fixing screw, and a lead-out hole 112c formed on one side of an upper surface to draw out the (+) and (−) voltage input lines 132a and 132b of the water treatment power converter 130, which are connected to the (+) electrode line among the power lines supplied from the outside.

In addition, the water treatment gap-maintaining member 120 may be formed as a rectangular enclosure with an open upper surface and configured to be inserted into the water treatment housing 110 and accommodate the water treatment power converter 130 and the water treatment high-voltage unit 140 therein, and the outer surface may be gradually widened from a lower side to an upper side, thereby increasing the pressure of inflowing water before discharge, in which the water treatment gap-maintaining member 120 may include a plurality of bottom spacing protrusions 121 formed on each corner of a bottom surface, defining a space between itself and the bottom surface of the water treatment housing 110 to allow the inflowing water to flow, and top spacing protrusions 122 formed on each corner of an upper surface, defining a space between itself and a bottom surface of the cover unit 112 of the water treatment housing 110 to allow the water to be discharged under increased pressure.

In addition, the water treatment power converter 130 may include a printed circuit board 131 including a controller, a connection portion 132 installed on a bottom surface of the printed circuit board 131 and including (+) and (−) voltage input lines 132a and 132b configured to be connected to external (+) and (−) electrode lines, in which the (−) voltage input line 132b is connected to the water treatment housing 110 together with the (−) electrode line, a transformer 133 installed behind the connection portion 132 on the bottom of the printed circuit board 131 to step up the supplied power, a high-voltage transformer 134 installed on one side of the transformer 133 on the bottom of the printed circuit board 131 to step up the stepped-up power to high voltage and connect the stepped-up power to the water treatment high-voltage unit 140 through a high voltage output line 134a, and a housing 135 for power converter, which is configured to accommodate the printed circuit board 131, the connection portion 132, the transformer 133, and the high-voltage transformer 134 therein.

As described above, according to the water treatment device with the simple configuration that uses the electrostatic field according to certain aspects of the disclosure, the water treatment device can be assembled and disassembled to and from a pipe through which water flows to treat the passing water into water with a reduced hardness that can be used as sterilizing water and can also suppress rust generation, and manufactured with a simple structure, thereby reducing manufacturing costs.

### BRIEF DESCRIPTION OF THE DRAWINGS

The above and other objects, features and advantages of the present disclosure will become more apparent to those of ordinary skill in the art by describing in detail exemplary aspects thereof with reference to the accompanying drawings in which:

FIG. 1 is a perspective view showing a water treatment device with a simple configuration that uses an electrostatic field according to an aspect of the disclosure;

FIG. 2 is an exploded perspective view showing the water treatment device with the simple configuration that uses the electrostatic field according to an aspect of the disclosure;

FIG. 3 is a bottom exploded perspective view illustrating the water treatment device with the simple configuration that uses the electrostatic field according to an aspect of the disclosure;

FIG. 4 is a cross-sectional view showing the water treatment device with the simple configuration that uses the electrostatic field in an assembled state, according to an aspect of the disclosure; and

FIG. 5 is a diagram illustrating a part of a power converter for water treatment of the water treatment device with the simple configuration that uses the electrostatic field according to an aspect of the disclosure.

### DETAILED DESCRIPTION

Hereinafter, a water treatment device with a simple configuration that uses an electrostatic field according to an aspect of the disclosure will be described in detail.

First, it should be noted that in the drawings, identical components or parts are given the same reference numerals whenever possible. In describing the present disclosure, detailed descriptions of the related well-known functions or configurations are omitted so as not to obscure the gist of the disclosure.

As shown, a water treatment device 100 with a simple configuration that uses an electrostatic meter according to an aspect of the disclosure includes a water treatment housing 110 installed on a pipe through which water flows, allowing the water to enter and exit, and including a power line passage hole 112c formed on one side of an upper surface to receive power through a power line of a power supply unit (not illustrated), a water treatment gap-maintaining member 120 made of a non-conductive material, which is formed as an enclosure with an open upper surface and configured such that, when accommodated in the water treatment housing 110, an outer peripheral surface thereof can be spaced apart so as not to obstruct an inflow of water, and the outer peripheral surface is gradually widened from a lower side toward an upper side, thereby increasing the pressure of the inflowing water before discharge, a water treatment power converter 130 accommodated in the water treatment gap-maintaining member 120 and including (+) and (−) voltage input lines 132a and 132b and a high voltage output line 134a to receive power from outside through power lines (not illustrated) and convert an input voltage into high voltage and output the high voltage, in which the (+) electrode lines of the power lines are connected to each other, and the (−) electrode lines are connected together to the water treatment housing 110, a water treatment high-voltage unit 140 provided as a conductor between the water treatment power converter 130 and the water treatment gap-maintaining member 120 and connected to the high voltage output line 134a, thereby generating static electricity between itself and an inner surface of the water treatment housing 110, and a water treatment epoxy molding layer 150 filled on an upper surface of the water treatment power converter 130 to electrically isolate the same and also to prevent water with an altered hardness from externally leaking through a power line passage hole of the water treatment housing 110.

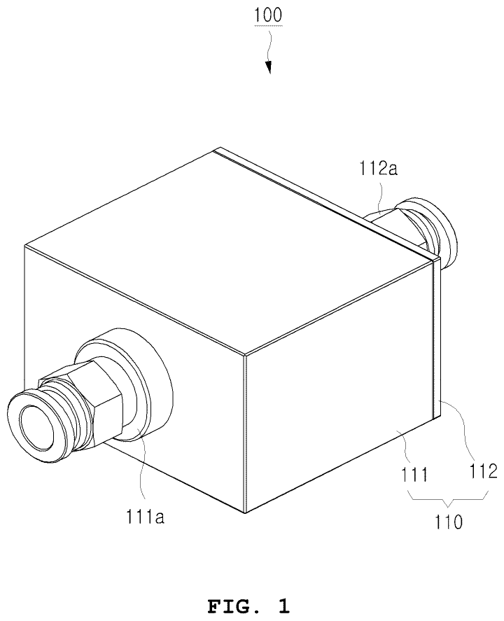

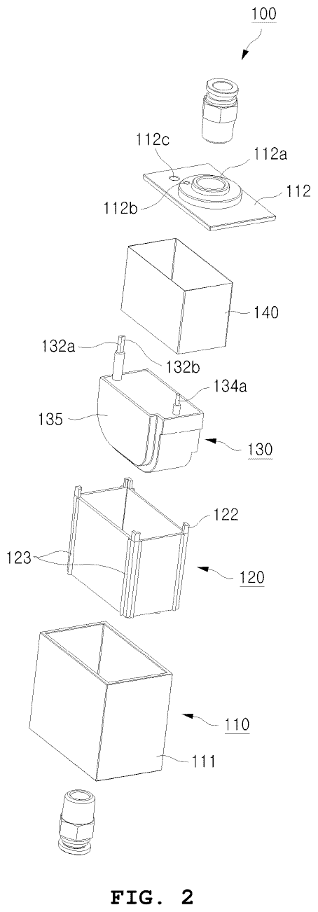

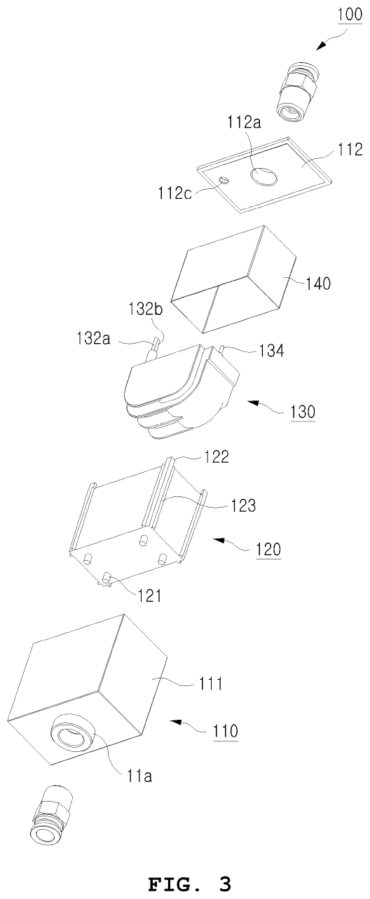

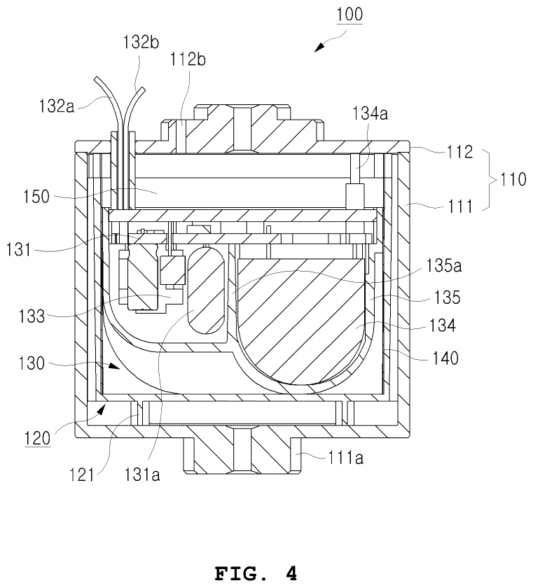

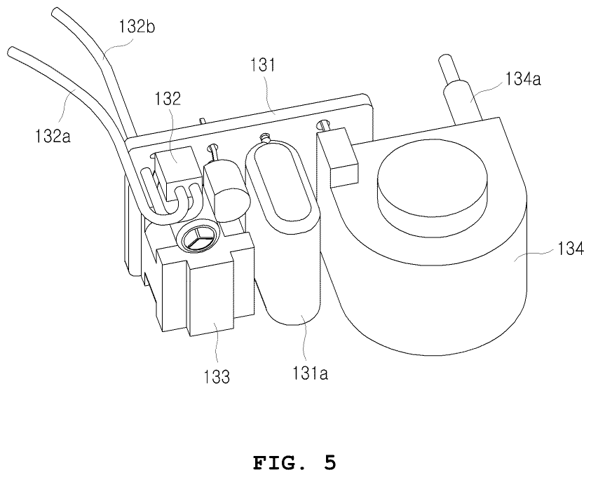

Hereinafter, the water treatment device with the simple configuration that uses the electrostatic meter according to an aspect of the disclosure will be described in more detail with reference to the accompanying drawings, FIGS. 1 to 5.

First, the water treatment housing 110 of the water treatment device according to an aspect of the disclosure is installed on a pipe through which water flows, allowing the water to enter and exit, and includes a power line passage hole formed on one side of the upper surface to receive power through a power line of the power supply (not illustrated).

That is, the water treatment housing 110 includes a receptacle 111 formed as a rectangular enclosure and including an inlet 111a formed on one side to be connected to a first pipe to allow water to enter, in which the other side open, and a cover unit 112 formed as a rectangular plate to cover an upper surface of the receptacle 111 and be fixed with a plurality of fixing screws with a leak-prevention ring interposed therebetween, and including an outlet 112a formed in a center of the plate to allow water with reduced hardness to be discharged to a second pipe side.

In addition, a fixing screw groove 112b is further formed on one side of the outlet 112a of the cover unit 112, through which the (−) voltage input line 132b of the water treatment power converter 130 is connected to the (−) electrode line of the power lines supplied from the outside and then welded or fixed together by means of the fixing screw.

In addition, a lead-out hole 112c is further formed on one side of an upper surface of the cover 112 to draw out the (+) and (−) voltage input lines 132a and 132b of the water treatment power converter 130, which are connected to the (+) electrode line among the power lines supplied from the outside.

The water treatment gap-maintaining member 120 is formed as an enclosure with an open upper surface and is configured such that, when accommodated in the water treatment housing 110, an outer peripheral surface thereof is spaced apart so as not to obstruct an inflow of water, and the outer peripheral surface is gradually widened from a lower side toward an upper side, thereby gradually increasing the pressure of the inflowing water before discharge,

That is, the water treatment gap-maintaining member 120 is formed as a rectangular enclosure with an open upper surface and configured to be inserted into the water treatment housing 110 and accommodate the water treatment power converter 130 and the water treatment high-voltage unit 140 therein, and the outer surface is gradually widened from a lower side to an upper side, thereby increasing the pressure of the inflowing water before discharge, in which the water treatment gap-maintaining member 120 includes a plurality of bottom spacing protrusions 121 formed on each corner of a bottom surface, defining a space between itself and the bottom surface of the water treatment housing 110 to allow the inflowing water to flow, and top spacing protrusions 122 formed on each corner of an upper surface, defining a space between itself and a bottom surface of the cover unit 112 of the water treatment housing 110 to allow the water to be discharged under increased pressure.

In addition, a plurality of anti-tilting protrusions 123 are further provided, which protrude from both sides of the front, rear, left, and right sides of the water treatment gap-maintaining member 120 so that, when the water treatment gap-maintaining member 120 is inserted into the water treatment housing 110 while making contact with the inner surface and the water enters through the inlet 111a and is discharged through the outlet 112a, the water treatment gap-maintaining member 120 is prevented from being tilted to one side of an inner surface of the water treatment housing 110.

The water treatment power converter 130 is accommodated in the water treatment gap-maintaining member 120 and includes the (+) and (−) voltage input lines and the high voltage output line connected to the water treatment high-voltage unit to receive power from outside through the power lines and convert the input voltage into high voltage and output the high voltage, in which the (+) electrode lines of the power lines are connected to each other, and the (−) electrode lines are connected together to the water treatment housing.

That is, the water treatment power converter 130 includes a printed circuit board 131 including a controller, a connection portion 132 installed on a bottom surface of the printed circuit board 131 and including (+) and (−) voltage input lines 132a and 132b configured to be connected to external (+) and (−) electrode lines, in which the (−) voltage input line 132b is connected to the water treatment housing 110 together with the (−) electrode line, a transformer 133 installed behind the connection portion 132 on the bottom of the printed circuit board 131 to step up the supplied voltage of 1 to 5V to 200 V, a high-voltage transformer 134 installed on one side of the transformer 133 on the bottom of the printed circuit board 131 to step up the stepped-up voltage of 200 V to 15,000 to 20,000 V and connect the stepped-up voltage to the water treatment high-voltage unit 140 through a high voltage output line 134a, and a housing 135 for power converter, which is configured to accommodate the printed circuit board 131, the connection portion 132, the transformer 133, and the high-voltage transformer 134 therein.

In an example, a partitioning diaphragm 135a is further provided, protruding from a bottom surface of the power converter housing 135 to accommodate the transformer 133 and the high-voltage transformer 134 in separate spaces.

The water treatment high-voltage unit 140, formed of a conductive copper plate, is provided between the water treatment power converter 130 and the water treatment gap maintenance member 120 and is connected to the high voltage output line 134a of the water treatment power converter 130, thereby generating static electricity between itself and the inner surface of the water treatment housing 110.

That is, the water treatment high-voltage unit 140 is provided between the water treatment power converter 130 and the water treatment gap-maintaining member 120 and is connected to the high voltage output line 134a of the water treatment power converter 130, thereby generating the static electricity between itself and the inner surface of the water treatment housing 110 to reduce the hardness of the inflowing and outflowing water.

As described above, the water treatment device with a simple configuration that uses electrostatic field according to some aspects of the disclosure has a simple configuration including the water treatment housing 110, the water treatment gap-maintaining member 120, the water treatment power converter 130 accommodated in the water treatment gap maintenance member 120, the water treatment high-voltage unit 140 provided between the water treatment power converter 130 and the water treatment gap maintenance member 120, and the water treatment epoxy molding layer 150, thereby reducing manufacturing cost during manufacturing, and the water treatment device with the simple configuration that uses the electrostatic field can be installed on a pipe to reduce the hardness of water upon application of power.

The above description is merely illustrative of the technical idea of the present invention, and those of ordinary skill in the art to which the present invention pertains will be able to make various modifications and variations without departing from the essential characteristics of the present invention. Accordingly, the embodiments described herein in the present invention are not intended to limit the technical idea of the present invention, but to explain the technical idea, and the scope of the technical idea of the present invention is not limited by these an embodiment. The scope of protection of the present invention should be interpreted by the following claims, and all technical ideas within the scope equivalent thereto should be construed as being included in the scope of the present invention.

1. A water treatment device with a simple configuration that uses an electrostatic field, the water treatment device comprising:
a water treatment housing (110) installed on a pipe through which water flows, allowing the water to enter and exit, and including a power line passage hole (112c) formed on one side of an upper surface to receive power through a power line of a power supply unit;
a water treatment gap-maintaining member (120) made of a non-conductive material, which is formed as an enclosure with an open upper surface and configured such that, when accommodated in the water treatment housing (110), an outer peripheral surface thereof can be spaced apart so as not to obstruct an inflow of water;
a water treatment power converter (130) accommodated in the water treatment gap-maintaining member (120) and including (+) and (−) voltage input lines (132a and 132b) and a high voltage output line (134a) to receive power from outside through power lines and convert an input voltage into high voltage and output the high voltage, wherein the (+) electrode lines of the power lines are connected to each other, and the (−) electrode lines are connected together to the water treatment housing (110);
a water treatment high-voltage unit (140) provided as a conductor between the water treatment power converter (130) and the water treatment gap-maintaining member (120) and connected to the high voltage output line (134a), thereby generating static electricity between itself and an inner surface of the water treatment housing (110); and
a water treatment epoxy molding layer (150) filled on an upper surface of the water treatment power converter (130) to electrically isolate the same and also to prevent the water with an altered hardness from externally leaking through the power line passage hole of the water treatment housing (110).

2. The water treatment device according to claim 1, wherein the water treatment housing (110) includes: a receptacle (111) formed as an enclosure and including an inlet (111a) formed on one side to be connected to a first pipe to allow water to enter, wherein the other side open; and a cover unit (112) formed as a plate to cover an upper surface of the receptacle (111) and fixed, and including an outlet (112a) formed in a center of the plate to allow water with reduced hardness to be discharged to a second pipe side, a fixing screw groove (112b) is further formed on one side of the outlet (112a) of the cover unit (112), through which the (−) voltage input line (132b) of the water treatment power converter (130) is connected to the (−) electrode line of the power lines supplied from the outside and then welded or fixed together by means of a fixing screw, and a lead-out hole (112c) is further formed on one side of an upper surface to draw out the (+) and (−) voltage input lines (132a and 132b) of the water treatment power converter (130), which are connected to the (+) electrode line among the power lines supplied from the outside.

3. The water treatment device according to claim 1, wherein the water treatment gap-maintaining member (120) is formed as a rectangular enclosure with an open upper surface and configured to be inserted into the water treatment housing (110) and accommodate the water treatment power converter (130) and the water treatment high-voltage unit (140) therein, and the outer surface is gradually widened from a lower side to an upper side, thereby increasing the pressure of inflowing water before discharge, and the water treatment gap-maintaining member (120) includes a plurality of bottom spacing protrusions (121) formed on each corner of a bottom surface, defining a space between itself and the bottom surface of the water treatment housing (110) to allow the inflowing water to flow, and top spacing protrusions (122) formed on each corner of an upper surface, defining a space between itself and a bottom surface of the cover unit (112) of the water treatment housing (110) to allow the water to be discharged under increased pressure.

4. The water treatment device according to claim 1, wherein the water treatment power converter (130) includes: a printed circuit board (131) including a controller; a connection portion (132) installed on a bottom surface of the printed circuit board (131) and including (+) and (−) voltage input lines (132a and 132b) configured to be connected to external (+) and (−) electrode lines, in which the (−) voltage input line (132b) is connected to the water treatment housing (110) together with the (−) electrode line; a transformer (133) installed behind the connection portion (132) on the bottom of the printed circuit board (131) to step up the supplied power; a high-voltage transformer (134) installed on one side of the transformer (133) on the bottom of the printed circuit board (131) to step up the stepped-up power to high voltage and connect the stepped-up power to the water treatment high-voltage unit (140) through a high voltage output line (134a); and a housing (135) for power converter, which is configured to accommodate the printed circuit board (131), the connection portion (132), the transformer (133), and the high-voltage transformer (134) therein.

5. The water treatment device according to claim 3, further comprising a plurality of anti-tilting protrusions (123) protruding from both sides of front, rear, left, and right sides of the water treatment gap-maintaining member (120) so that, when the water treatment gap-maintaining member (120) is inserted into the water treatment housing (110) while making contact with the inner surface and the water enters through the inlet (111a) and is discharged through the outlet (112a), the water treatment gap-maintaining member (120) is prevented from being tilted to one side of an inner surface of the water treatment housing (110).

6. The water treatment device according to claim 4, comprising a partitioning diaphragm (135a) protruding from a bottom surface of the power converter housing (135) to accommodate the transformer (133) and the high-voltage transformer (134) in separate spaces.

7. The water treatment device according to claim 3, wherein the water treatment power converter (130) includes: a printed circuit board (131) including a controller; a connection portion (132) installed on a bottom surface of the printed circuit board (131) and including (+) and (−) voltage input lines (132a and 132b) configured to be connected to external (+) and (−) electrode lines, in which the (−) voltage input line (132b is connected to the water treatment housing (110) together with the (−) electrode line; a transformer (133) installed behind the connection portion (132) on the bottom of the printed circuit board (131) to step up the supplied power; a high-voltage transformer (134) installed on one side of the transformer (133) on the bottom of the printed circuit board (131) to step up the stepped-up power to high voltage and connect the stepped-up power to the water treatment high-voltage unit (140) through a high voltage output line (134a); and a housing (135) for power converter, which is configured to accommodate the printed circuit board (131), the connection portion (132), the transformer (133), and the high-voltage transformer (134) therein.

8. The water treatment device according to claim 7, comprising a partitioning diaphragm (135a) protruding from a bottom surface of the power converter housing (135) to accommodate the transformer (133) and the high-voltage transformer (134) in separate spaces.
